(19) United States
(12) Patent Application Publication
(10) Pub. No.: US 2008/0240594 A1
(43) Pub. Date: Oct. 2, 2008

(54) Compression of triangle stripped data

(76) Inventors: Elena Guschina, Nizhegorodsky Reg (RU); Vladimir Tatarinov, Nizhegorodsky Reg (RU)

Correspondence Address: TROP PRUNER & HU, PC, 1616 S. VOSS ROAD, SUITE 750, HOUSTON, TX, 77057-2631, US

(21) Appl. No.: 11/729,892

(22) Filed: Mar. 29, 2007

(51) Int. Cl. G06K 9/36

(52) U.S. Cl. 382/243; 382/233

(57) ABSTRACT

A coder/decoder of a computer system may be utilized to compress, for subsequent display, three dimensional images. A triangle strip from a triangle based mesh may be analyzed to produce a sequence code to indicate a difference between a subsequent index and a previous index of a vertex within the triangle strip. The indices are reordered based on the order of occurrence in the strip.

### BACKGROUND

This relates to the compression and decompression of three dimensional graphic models.

In order to process, store, and display three dimensional graphics, a model may be generated of the graphics. The model may be useful in encoding the image for subsequent manipulation, storage, or display. The model may also be used in order to compress the data that represents the image in a way that decreases the amount of storage necessary to store the image.

One popular compression technique for three dimensional graphic models is to use a triangular mesh. A typical triangular mesh consists of two different types of data: topological data that specify the connectivity of the mesh and geometrical data that describes information associated with each individual vertex of the mesh. Thus, in a triangular mesh, the image consists of a set of triangles, each having three vertices. Each vertex, in turn, is represented as a triple of coordinates (for 3D space) and has an index associated with it.

### BRIEF DESCRIPTION OF THE DRAWINGS

FIG. 1 is a hardware depiction of one embodiment of the present invention; and

FIG. 2 is a depiction of a sequence in accordance with one embodiment of the present invention.

### DETAILED DESCRIPTION

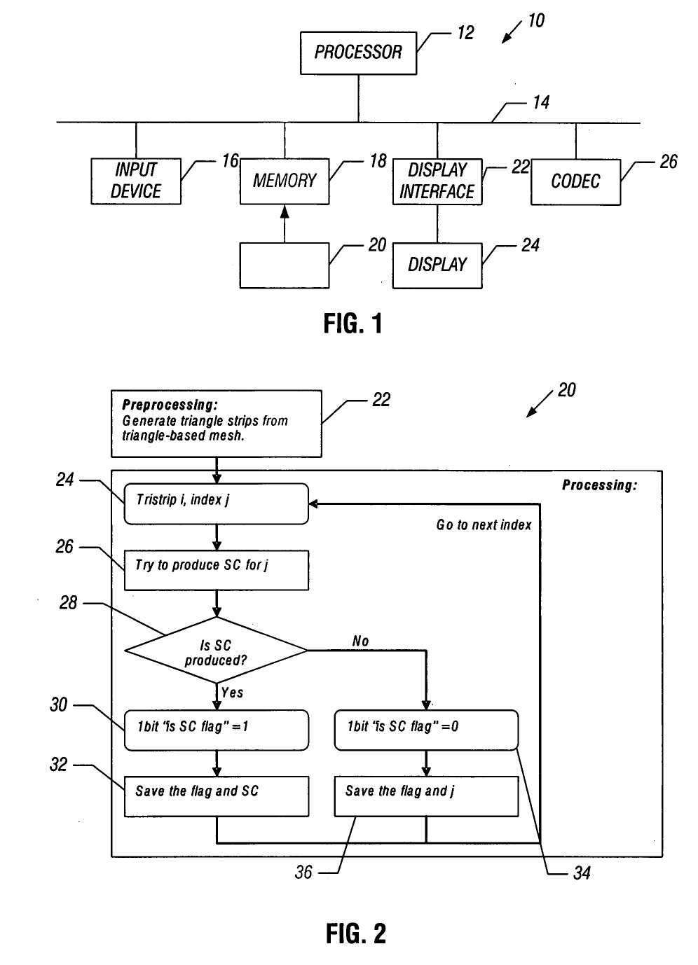

Referring to FIG. 1, a typical computer system 10 may include a processor 12 coupled by a bus 14 to other components. In some embodiments, multiple processors 12 may be utilized. In other embodiments, a variety of different system architectures may be implemented.

A bus 14 may be connected to an input device 16, such as a camera, a scanner, a storage device, or any other input device. Also coupled to the bus 14 may be a memory 18. The memory 18 may be any kind of storage device and may store a sequence 20 in the form of software or firmware in one embodiment.

A display interface 22 and a display 24 may be coupled to the bus 24 as well. Finally, a coder/decoder 26 may be coupled to the bus. The coder/decoder 26 may be implemented in software, in some embodiments, and in hardware in other embodiments. It may receive an input image in the form of data and may compress that information into a coded sequence for storage in a memory, such as the memory 18. It may also receive data stored in compressed form in the memory 18 and may implement decompression.

In accordance with one embodiment of the present invention, a triangular mesh may be simplified using a set of triangles strips. A strip of triangles is merely a run of adjacent triangles which can be conveniently handled as a group. The strips may then be coded based on the indices of the individual vertices making up the strip. Each strip may be coded as follows:

N, 1^{st} index, 2^{nd} index . . . N^{th} index,

where N is the number of indices in the strip.

Thus, in the above sequence, the first number will be the number of indices in the strip and each of the indices points to corresponding vertex in the mesh.

Rather than simply saving indices, sequences of indices that occur frequently in the strips are identified. The sequences are then coded using fewer bits than would be utilized if every index were coded using dynamic or static histograms.

In one embodiment, four different types of sequences are identified. For each type, a two-bit sequence code (SC) is provided. In one embodiment, if separate storage is chosen where geometry and connectivity data are stored in separate blocks, a sequence code of 0 indicates that the index may be reconstructed from the previous index plus 1. A sequence code of 1 indicates that the index may be reconstructed from the previous code minus 1. A sequence code of 2 indicates that the sequence may be reconstructed from the second previous code plus 1. A sequence code of 3 indicates a long sequence of sequence code 0.

In one embodiment, if a mixed storage is chosen where geometry and connectivity data are mixed in one block, then a sequence code of 0 is reconstructed from the previous index plus 1. A sequence code of 1 indicates that the index may be reconstructed from the previous index minus 1. A sequence code of 2 indicates that the sequence may be reconstructed from the second previous sequence code plus 1. A sequence code of 3 indicates that the sequence code may be reconstructed from the second previous code minus 1.

The more elements in the strips that fit a sequence code, the better the compression ratio that is achieved. To improve the compression ratio, an indices reordering procedure may be done before coding. Each of the vertex indices, in the order that they are encountered along the strip, are coded starting with 0 and incrementing by one. When a vertex with the same index repeats, it is then recoded with the same numeric code. For example, if an initial strip with 14 vertices has the code 14, 2, 7, 4, 3, 9, 8, 0, 1, 3, 5, 7, 6, 9, 0 it would be recoded as 14, 0, 1, 2, 3, 4, 5, 6, 7, 3, 8, 1, 9, 4, 6. The first index in the code (2) is arbitrarily reset as 0. The second index of 7 is arbitrarily set as 1. Since the indices do not repeat, the indices 2, 7, 4, 3, 9, 8, 0, 1 are simply coded consecutively from 0 to 7. The first index that repeats is the index 3. Since the index 3 has already been set equal to 3 in the new code, it maintains that code in the new code when repeated at a different position. Then the flow continues incrementing to 8. Then the next index in the old code is 7, which has already been set equal to 1. The next position in the old code is 6 which is given the next sequential number 9, the next position in the old code is 9 which has already been set equal to 4, and the last position in the old code 0, is set equal to 6 because 0 has already been assigned for 6.

After this coding is done, the sequence codes are assigned based on the new code. Thus, the sequence codes in this example, if separate storage is chosen, are 14, (0, 0), (1, 0), (1, 0), (1, 0), (1, 0), (1, 0), (1, 0), (1, 0), (0, 3), (1, 2), (0, 1), (1, 2), (0, 4), (0, 6) where first element in each pair is “is SC flag” and the second one is a sequence code or plain index depending on the flag. The zero sequence codes repeat in along sequence so the subsequence (1, 0), (1, 0), (1, 0), (1, 0), (1, 0), (1, 0), (1, 0) can be reduced to a triple (1, 3,) where 1 is “is SC flag”, 3 is a sequence code and 7 is a length of the subsequence.

Referring to FIG. 2, the coding algorithm 20 may be encoded in software, hardware, or firmware in some embodiments. The algorithm 20 may, for example, be software stored on the memory 18 as shown in FIG. 1. In FIG. 2, prior to starting the processing, the triangle strips are generated from the triangle base mesh (as indicated in block 22) in a well known fashion. Initially, at block 24, a first triangle strip i, index j is assigned to be processed. At 26, the sequence codes (SC) are assigned. If the sequence code assumed is successful, as determined in diamond 28, a sequence code flag is set equal to 1 in block 30 and in block 32 the flag and the sequence code are saved. If no sequence code can be assigned, then the sequence code flag is set equal to 0 in block 34 and the flag and index itself are saved (block 36).

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A computer readable medium storing instructions that, if executed, enable a computer to:
receive a triangle strip from a triangle based mesh;
produce a sequence code to indicate a difference between a subsequent index and a previous index; and
reorder the indices based on the order of occurrence in the strip.

2. The medium of claim 1 storing instructions to assign different sequence codes when the difference between previous and subsequent indices is positive or negative one.

3. The medium of claim 2 storing instructions to assign a sequence code based on the difference between a second previous and a subsequent index.

4. The medium of claim 1 storing instructions to reorder by numbering the first vertex as zero and incrementing each ensuing index.

5. The medium of claim 4 includes assigning sequence codes based on the reordered indices.

6. The medium of claim 5 further storing instructions to use different sequence codes depending on whether geometry and conductivity data are stored separately or are mixed.

7. The medium of claim 6 further storing instructions to compress a three dimensional image using said triangle strip, store said three dimensional image, decompress said three dimensional image, and display said decompressed image.

8. A system comprising:
a processor; and
a coder/decoder coupled to said processor to receive a triangle strip from a triangle based mesh, to produce a sequence code to indicate a difference between a subsequent index and a previous index, and to reorder the indices based on the order of sequence in the strip.

9. The system of claim 8 including a display to display decompressed images.

10. The system of claim 8, said coder/decoder to assign different sequence codes when the difference between the previous and subsequent indices is positive or negative.

11. The system of claim 10, said coder/decoder to assign a sequence code based on the difference between a second previous and a subsequent index.

12. The system of claim 8 including a coder/decoder to reorder by numbering the first vertex a zero and increment each ensuing index.

13. The system of claim 12 further storing instructions to assign sequence codes based on the ordered indices.
